(19) United States
(12) Patent Application Publication
(10) Pub. No.: US 2004/0162746 A1
(43) Pub. Date: Aug. 19, 2004

(54) Information provision system and information provision method

(76) Inventor: Kenichiro Masunaga, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/763,183

(22) Filed: Jan. 26, 2004

(30) Foreign Application Priority Data
Feb. 19, 2003 (JP) P2003-40560

(51) Int. Cl. G06F 17/60

(52) U.S. Cl. 705/7

(57) ABSTRACT

Facilitating the unifying of management of information on a plurality of manufacture entrusted companies without development cost for a new system, in the case of consigning the manufacture to a plurality of manufacture entrusted companies. An information provision system comprising: a database for unifying management of production progress information on a plurality of manufacturers; a storage processing means for storing, into the database, the production progress information on the plurality of manufacturers transmitted based on a common specification; and a display data creation processing means for extracting necessary information from information managed in the database, in response to a request from a manufacture consignment source, and for creating display data, wherein the display data is transmitted to a terminal of the manufacture consignment source and is displayed thereon.

### BACKGROUND OF THE INVENTION

The present invention relates to an information provision system and an information provision method and, particularly, to a technique effectively applied to a system for unifying management of production progress information, quality information, and the like when manufacture is consigned to a plurality of manufacturers.

In recent years, separation of design and manufacture has progressed in manufacture industry. Further, reduction of stocks by introducing SCM (Supply Chain Management) or the like is actively carried out, and it is impossible to unify the management of production progress and stock information.

Meanwhile, fabless manufacturers each having no manufacture plant select optimum manufacture entrusted companies in accordance with product class form, production TAT (Turn Around Time), and production cost.

Therefore, a relationship between the fabless manufacturers (manufacture consignment sources) and the manufacture entrusted companies has been made a complex form in which a plurality of companies in proportion of n to m (n, m: number more than 1) are mixed.

Under such circumstances, the fabless manufacturers individually collect production progress information from the manufacture entrusted companies to which the manufacture is consigned, in order to manage the production progress status of their own products whose manufacture is consigned.

However, the collected production progress information is different in data specification for each manufacture entrusted company. Thus, to unify the management of the production progress information on a plurality of manufacture entrusted companies, the information collected in the individual fabless manufacturers has been converted into the same format, or the information has been individually converted in accordance with the specifications of the fabless manufacturers which are clients in the manufacture entrusted companies.

Further, systems for unifying the management of data such as the production progress information are also present (for example, see Patent Document 1), but these systems are mainly directed to no utilization for a common specification and to collection of the data in one location. Additionally, in these systems, the information on a plurality of plants owned by one manufacture entrusted company is a management target, and the management of the information on a plurality of companies is not unified (for example, see Patent Documents 2 to 5). Therefore, when the fabless manufacturer is manufacture-consigned to a plurality of manufacture entrusted companies, interfaces for production progress managing system have been individually required.

[Patent Document 1]

Japanese Patent Laid-open No. 11-250129

[Patent Document 2]

Japanese Patent Laid-open No. 2001-312536

[Patent Document 3]

Japanese Patent Laid-open No. 2001-326151

[Patent Document 4]

Japanese Patent Laid-open No. 2002-15030

[Patent Document 5]

Japanese Patent Laid-open No. 2002-149747

### SUMMARY OF THE INVENTION

However, as a result of examinations by the present inventors as to a method of unifying the management of the data such as the above-mentioned production progress information, the followings have been found.

For example, when manufacture entrusted companies provide production progress information on a browser for each client through the Internet, a fabless manufacturer which is a client has to convert the respective pieces of production progress information supplied from different manufacture entrusted companies to its own format and to fetch the converted information into its own production progress information system.

Further, when data of the production progress information based on the specification of the client is created in the manufacture entrusted company to be transmitted to the client's system, a transmission format of the production progress information managing system is different for each client so that the manufacture entrusted company has to create data based on the client's specification.

Thus, when the fabless manufacturer consigns the manufacture to a plurality of manufacture entrusted companies, development of a data conversion management function is individually required to unify the management of the data such as the production progress information in the fabless manufacturer and development cost for the production progress managing system occurs, whereby the production progress information has been difficult to unify the management of.

Therefore, an object of the present invention is to facilitate the unifying of management of information on a plurality of manufacture entrusted companies without development cost for a new system, in the case of consigning the manufacture to a plurality of manufacture entrusted companies.

The above and other objects and novel features of the present invention will be apparent from the description of this specification and the accompanying drawings.

Outlines of the typical ones of the inventions disclosed in this application will be briefly described as follows.

(1) An information provision system according to the present invention comprises: a database for unifying management of production progress information on a plurality of manufacturers; a storage processing means for storing, into said database, the production progress information on said plurality of manufacturers transmitted based on a common specification; and a display processing means for extracting necessary information from information managed in said database, in response to a request from a manufacture consignment source, and for creating display data, wherein said display data is transmitted to a terminal of the manufacture consignment source and is displayed thereon.

(2) An information provision system according to the present invention comprises: a database in a manufacture consignment source for unifying management of production progress information on a plurality of manufacturers; a storage processing means for storing, into said database, the production progress information on said plurality of manufacturers transmitted based on a common specification, the storage processing means being provided in the manufacture consignment source; a display data creation processing means for extracting necessary information from information managed in said database and for creating display data, the display data creating means being provided in the manufacture consignment source; and a display processing means for displaying said display data on a terminal provided in the manufacture consignment source.

(3) In the information provision system according to items (1), information on said plurality of manufacturers is displayed on the same screen of said terminal in a display processing said display data.

(4) In the information provision system according to items (2), information on said plurality of manufacturers is displayed on the same screen of said terminal in a display processing said display data.

(5) In the information provision system according to items (1), information managed in said database includes information such as manufacturer, product class, lot number, quantity, working steps, and forecast complete date.

(6) In the information provision system according to item (2), information managed in said database includes information such as manufacturer, product class, lot number, quantity, working steps, and forecast complete date.

(7) In the information provision system according to items (3), information managed in said database includes information such as manufacturer, product class, lot number, quantity, working steps, and forecast complete date.

(8) In the information provision system according to items (4), information managed in said database includes information such as manufacturer, product class, lot number, quantity, working steps, and forecast complete date.

(9) In the information provision system according to items (5), the information managed in said database further includes quality information.

(10) In the information provision system according to items (6), the information managed in said database further includes quality information.

(11) In the information provision system according to items (7), the information managed in said database further includes quality information.

(12) In the information provision system according to items (8), the information managed in said database further includes quality information.

(13) In the information provision system according to items (1), information managed in said database is quality information instead of production progress information.

(14) In the information provision system according to items (2), information managed in said database is quality information instead of production progress information.

(15) In the information provision system according to items (3), information managed in said database is quality information instead of production progress information.

(16) In the information provision system according to items (4), information managed in said database is quality information instead of production progress information.

(17) An information provision method according to the present invention comprises the steps of: storing, into a database, production progress information on a plurality of manufacturers transmitted based on a common specification; extracting necessary information from information managed in said database in response to a request from a manufacture consignment source, and creating display data; and transmitting said display data to a terminal of the manufacture consignment source.

(18) An information provision method according to the present invention comprises the steps of: storing production progress information on a plurality of manufacturers transmitted based on a common specification, into a database in a manufacture consignment source; extracting necessary information from information managed in said database, and creating display data; and displaying said display data on a terminal in the manufacture consignment source.

Therefore, according to the information provision system of items (1) to (16) and the information provision method of items (17) and (18), it is possible to easily unify management of information on the plurality of manufacturers without requiring development cost for a new system when the manufacture consignment source consigns the manufacture to the plurality of manufacturers.

### BRIEF DESCRIPTION OF THE DRAWINGS

FIG. 1 is a block diagram showing a structure of and an information flow in an information provision system according to a first embodiment of the present invention.

FIG. 2 is a block diagram showing one example of a display screen of a user terminal in a manufacture consignment source.

FIG. 3 is a block diagram showing a structure of and an information flow in an information provision system according to a second embodiment of the present invention.

### DESCRIPTION OF THE PREFERRED EMBODIMENTS

Embodiments of the present invention will be below detailed based on the drawings. Note that, through all the drawings for describing the embodiments, the same members are denoted by the same numeral symbol and the repetitive description thereof will be omitted.

### (First Embodiment)

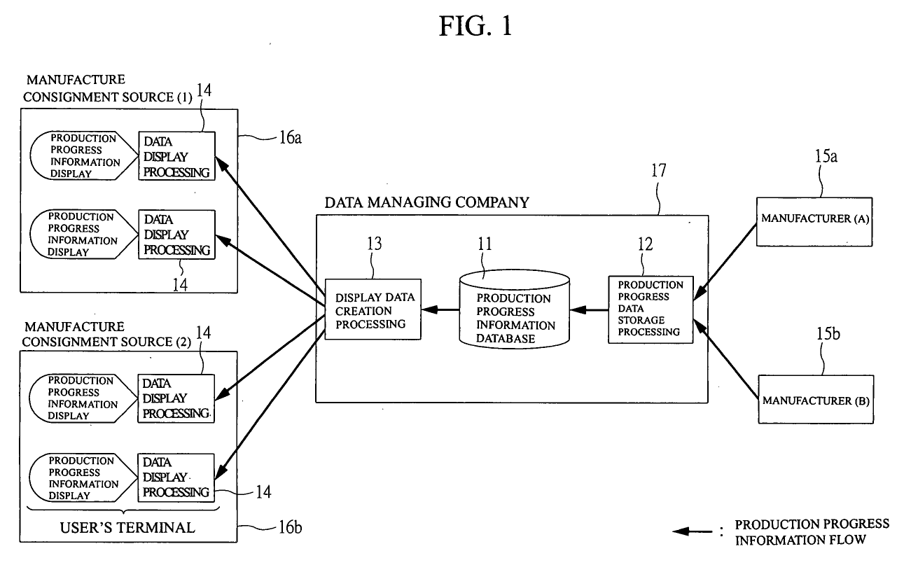

FIG. 1 is a block diagram showing a structure of and an information flow in an information provision system according to a first embodiment of the present invention.

First, with reference to FIG. 1, one example of a structure of an information provision system according to a first embodiment will be described. An information provision system according to the first embodiment is, for example, directed to a system utilizing a computer, and comprises a production progress information database 11, a production progress data storage processing means 12, a display data creation processing means 13, a data display processing means 14, and the like.

The production progress information database 11 is a database for unifying management of production progress information on a plurality of manufacturers.

The production progress data storage processing means 12 is a means for storing, into the production progress information database 11, the production progress information on a plurality of manufactures transmitted based on a common specification, and is constructed by hardware or software.

The display data creation processing means 13 is a means for extracting necessary information from the information managed in the production progress information database 11 in response to a request from a manufacture consignment source and for creating display data, and is constructed by hardware or software.

The data display processing means 14 is a means for displaying the production progress information on a plurality of manufacturers at a user terminal in the manufacture consignment source.

Next, one example of utilization form of the information provision system according to the first embodiment will be described. Manufacture consignment sources 16a and 16b are fabless manufacturers or the like, and are companies which consign the manufacture of their own products to manufacturers 15a and 15b and the like. The manufacturers 15a and 15b are manufacture entrusted companies which receive manufacture consignment from the manufacture consignment sources 16a and 16b such as fabless manufacturers. A data management company 17 is an independent company retaining the information provision system of the first embodiment, unifying the management of information such as the production progress information in the manufacturers 15a and 15b and the like, and carrying out information provision services for the manufacture consignment sources 16a and 16b and the like. In FIG. 1, two manufacture consignment sources and two manufacturers are respectively shown, but only one or more than two manufacture consignment sources may be employed. Further, more than two manufacturers may be employed. Additionally, in FIG. 1, two display devices (user terminals) are shown in the manufacture consignment source, but only one or more than two display devices may be employed.

At first, the manufacturers 15a and 15b and the like transmit production progress information on each manufacturer to the data management company 17 on the basis of a common specification.

The data management company 17 collects the production progress information transmitted from the plurality of manufacturers 15a and 15b and the like on the basis of the common specification.

Then, the collected information is fetched as data into the common production progress information database 11 by the production progress data storage processing means 12 irrespective of the manufacture consignment sources and the manufacturers. In other words, the production progress information transmitted from the manufacturers 15a and 15b and the like on the basis of the common specification is fetched as data into the production progress information database 11 by the same control program irrespective of the manufacturers.

The common data specification is unified so as to include at least the following items:

(1) Transmission data file identifiers;

(a) Manufacturer, and

(b) Data creation time/date or data transmission time/date,

(2) Data items;

(a) Manufacturer,

(b) Customer (fabless manufacturer)

(c) Product class,

(d) Lot number,

(e) Quantity,

(f) Working steps, and

(g) Forecast complete date.

The data management company 17 unifies the management of the production progress information on the plurality of manufacturers 15a and 15b and the like by the same control program in the production progress information database 11.

Then, by using the display data creation processing means 13 which is the same control program, in accordance with transaction of information display requests inputted from the user terminals of the manufacture consignment sources 16a and 16b and the like, necessary data is extracted from the production progress information database 11 to create display data.

The processing results are displayed on the terminal screens in the computer systems in the manufacture consignment sources via a browser by utilizing the Internet or the like.

Instead of providing the information via the browser, data browsing software may be provided to the manufacture consignment sources 16a and 16b and the like from the data management company 17.

Further, in the provision of the production progress information to the manufacture consignment source, it is also possible to display, on the same screen, the production progress information on a plurality of different manufacturers when the production progress information is displayed on the user terminals of the manufacture consignment source. By doing so, the unifying of the management of the production progress information on the plurality of different manufacturers is facilitated in the manufacture consignment source.

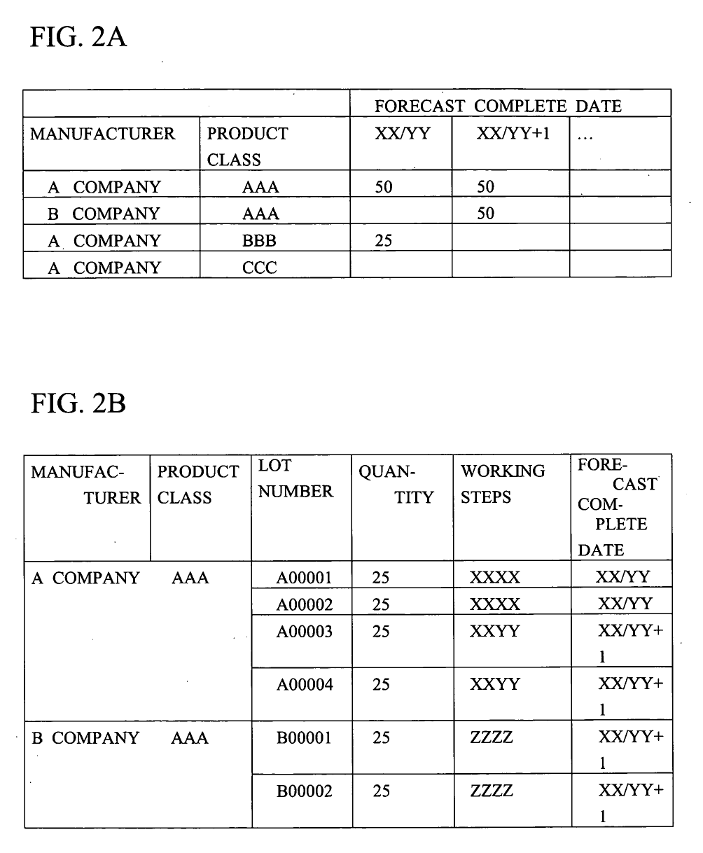

FIG. 2 is a block diagram showing one example of a display screen of a user terminal in a manufacture consignment source. In FIG. 2, the production progress information for each manufacturer is displayed on the screen, on which manufacturer, product class, forecast complete date, lot number, quantity, and working steps, etc. are displayed as items of the production progress information. For example, the production progress information, such as “‘50’ products having product class ‘AAA’ will be completed at ‘A’ company on ‘YY+1(day)/XX(month)’” and “‘50’ products having product class ‘AAA’ will be completed at ‘B’ company on ‘YY+1(day)/XX(month)’”, can be read from FIG. 2A. Since the information on the plurality of different manufacturers is displayed on the same screen, production progress management of the plurality of manufacturers is facilitated in the manufacture consignment source.

A series of control programs from the data-fetching into the production progress information database 11, to the managing of the database and the displaying of the production progress information onto the user terminal, is not different in the manufacture consignment sources and the manufacturers, whereby the same control program can be used for the above-mentioned series of control programs.

Further, as a data management company for making some information provision services, one enterprise which owns the information provision system with above functions according to the first embodiment makes the management and provision services of the production progress information on each manufacturer, with respect to the plurality of manufacture consignment sources.

Therefore, since the data management company, which makes the information provision services between the manufacture consignment source and the manufacturer, intensively carries out a series of operations from the data collection of the production progress information to the display data creation processing, the manufacture consignment source has only to hold a browser for browsing the data and thereby can facilitate the management of the production progress information on the plurality of manufacturers to which the manufacture of its own products is consigned.

Further, since the data specification of the production progress information to be collected is the same irrespective of manufacturers and a series of operations from the data-fetching to the display data creation processing can be achieved by the same program, the number of system developing steps in the data management company is also small. Therefore, when the manufacture consignment source adopts new manufacture entrusted companies, the number of steps of starting to provide the production progress information is shortened and the development of the new manufacture entrusted companies can be accelerated.

Thus, according to the information provision system of the first embodiment, it is easy to unify, in the manufacture consignment source, the management of the production progress information on the plurality of manufacturers to which the manufacture is consigned.

Further, the number of developing and managing steps in the production progress information managing system can be respectively reduced in the manufacture consignment source.

Furthermore, the number of customizing steps of providing the production progress information for each manufacture consignment source that is a client is reduced in the manufacturer.

The information provision system according to the first embodiment is particularly effective to the production progress managing system in semiconductor industries in which the separation of design and manufacture makes most progress between enterprises. Further, the production progress managing system can be applied to home electric appliance industry, electronic component industry, and the like.

### (Second Embodiment)

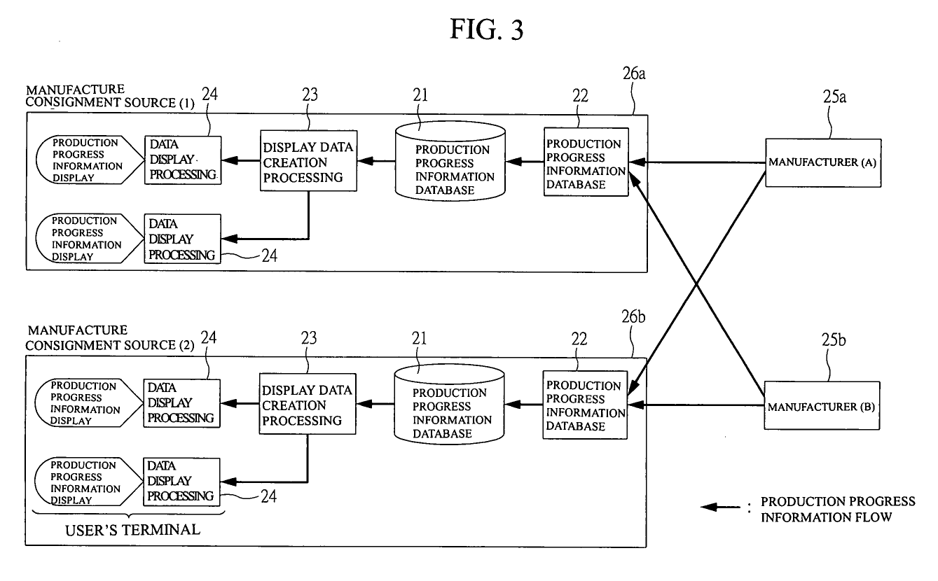

FIG. 3 is a block diagram showing a structure of and an information flow in an information provision system according to a second embodiment of the present invention.

First, with reference to FIG. 3, one example of a structure of an information provision system according to a second embodiment will be described. The information provision system according to the second embodiment is a variant of the above first embodiment, and has such a form that the production progress information database owned by the data management company in the above first embodiment is individually owned by the manufacture consignment sources.

The information provision system according to the second embodiment is, for example, a system utilizing a computer, and comprises a production progress information database 21, a production progress data storage processing means 22, a display data creation processing means 23, a data display processing means 24, and the like.

The respective functions are identical to those according to the first embodiment, but the second embodiment is different from the first embodiment in that each manufacture consignment source retains the same control program.

Next, one example of utilization form of the information provision system according to the second embodiment will be described. Manufacture consignment sources 26a and 26b are fabless manufacturers or the like, and are companies which consign manufacture of their own products to manufacturers 25a and 25b and the like, and retain the information provision system according to the second embodiment. The manufacturers 25a and 25b are manufacture entrusted companies which receive manufacture consignment from the manufacture consignment sources 26a and 26b such as fabless manufacturers. In FIG. 3, two manufacture consignment sources and two manufacturers are shown, but only one or more than two manufacture consignment sources may be employed. Further, more than two manufacturers may be employed. Additionally, in FIG. 3, two display devices (user terminals) are shown in each manufacture consignment source, but only one or more than two display devices may be employed.

At first, the manufacturers 25a and 25b and the like transmit the production progress information on each manufacturer to the manufacture consignment sources 26a and 26b on the basis of the common specification, similarly to the above first embodiment.

In the manufacture consignment sources 26a and 26b, data is stored in the production progress information database 21 on the basis of the common control program, by the production progress data storage processing means 22 irrespective of the manufacturers that are data supply sources.

In the manufacture consignment sources 26a and 26b, necessary information is extracted from the production progress information database 21, in accordance with transaction inputted from the user terminal, by the display data creation processing means 23 and the data display processing means 24, and is display on the screen of the user terminal.

When the production progress information is displayed on the screen of the user terminal, the information on the plurality of manufacturers can be displayed on the same screen similarly to the first embodiment.

A series of control programs from the storing of the production progress data to the displaying of the production progress information can be used in common irrespective of the manufacture consignment sources.

Therefore, according to the information provision system according to the second embodiment, also in the form in which the production progress information database 21 is individually owned by the manufacture consignment sources 26a and 26b, the same effects as those in the above-mentioned first embodiment can be obtained.

As described above, the inventions made by the inventors have been concretely described based on the embodiments. However, needles to say, the present invention is not limited to the above-mentioned embodiments and can be variously modified and altered without departing from the gist thereof.

For example, the production progress information managing system has been described in the above embodiments, but the present invention is not limited thereto, and can be applied to a quality managing system or the like utilized in the case of giving and receiving quality information, analysis information, and the like between the manufacture consignment source and the manufacturer. Particularly, as business is such that the separation of design and manufacture progresses between enterprises, the present invention is more effective.

Hereinbefore, the case where the invention made by the inventors is applied to the production managing system that is a technical field to which the invention belongs has been mainly described, but the present invention is not limited thereto and can be also applied to a distribution managing system and the like.

The effects obtained from the representative ones of the inventions disclosed by the present application will be described as follows.

(1) The management of information such as production progress information on the plurality of manufacturers is easily unified in the manufacture consignment source.

(2) The number of developing and managing steps of the production managing system such as a production progress information managing system is reduced in the manufacture consignment source.

(3) Development to a new manufacturer is accelerated in the manufacture consignment source.

(4) The number of customizing steps of providing the production progress information for each manufacture consignment source that is a client is reduced in the manufacturer.

What is claimed is:

1. An information provision system comprising:
a database for unifying management of production progress information on a plurality of manufacturers;
a storage processing means for storing, into said database, the production progress information on said plurality of manufacturers transmitted based on a common specification; and
a display processing means for extracting necessary information from information managed in said database, in response to a request from a manufacture consignment source, and for creating display data,
wherein said display data is transmitted to a terminal of the manufacture consignment source and is displayed thereon.

2. An information provision system comprising:
a database in a manufacture consignment source for unifying management of production progress information on a plurality of manufacturers;
a storage processing means for storing, into said database, the production progress information on said plurality of manufacturers transmitted based on a common specification, the storage processing means being provided in the manufacture consignment source;
a display data creation processing means for extracting necessary information from information managed in said database and for creating display data, the display data creating means being provided in the manufacture consignment source; and
a display processing means for displaying said display data on a terminal provided in the manufacture consignment source.

3. The information provision system according to claim 1,
wherein information on said plurality of manufacturers is displayed on the same screen of said terminal in a display processing said display data.

4. The information provision system according to claim 2,
wherein information on said plurality of manufacturers is displayed on the same screen of said terminal in a display processing said display data.

5. The information provision system according to claim 1,
wherein information managed in said database includes information such as manufacturer, product class, lot number, quantity, working steps, and forecast complete date.

6. The information provision system according to claim 2,
wherein information managed in said database includes information such as manufacturer, product class, lot number, quantity, working steps, and forecast complete date.

7. The information provision system according to claim 3,
wherein information managed in said database includes information such as manufacturer, product class, lot number, quantity, working steps, and forecast complete date.

8. The information provision system according to claim 4,
wherein information managed in said database includes information such as manufacturer, product class, lot number, quantity, working steps, and forecast complete date.

9 The information provision system according to claim 5,
wherein the information managed in said database further includes quality information.

10. The information provision system according to claim 6,
wherein the information managed in said database further includes quality information.

11. The information provision system according to claim 7,
wherein the information managed in said database further includes quality information.

12. The information provision system according to claim 8,
wherein the information managed in said database further includes quality information.

13. The information provision system according to claim 1,
wherein information managed in said database is quality information instead of production progress information.

14. The information provision system according to claim 2,
wherein information managed in said database is quality information instead of production progress information.

15. The information provision system according to claim 3,
wherein information managed in said database is quality information instead of production progress information.

16. The information provision system according to claim 4,
wherein information managed in said database is quality information instead of production progress information.

17. An information provision method comprising the steps of:
storing, into a database, production progress information on a plurality of manufacturers transmitted based on a common specification;
extracting necessary information from information managed in said database in response to a request from a manufacture consignment source, and creating display data; and
transmitting said display data to a terminal of the manufacture consignment source.

18. An information provision method comprising the steps of:
storing production progress information on a plurality of manufacturers transmitted based on a common specification, into a database in a manufacture consignment source;
extracting necessary information from information managed in said database, and creating display data; and
displaying said display data on a terminal in the manufacture consignment source.
